(19) United States
(12) Patent Application Publication
(10) Pub. No.: US 2014/0122082 A1
(43) Pub. Date: May 1, 2014

(54) APPARATUS AND METHOD FOR GENERATION OF PROSODY ADJUSTED SOUND RESPECTIVE OF A SENSORY SIGNAL AND TEXT-TO-SPEECH SYNTHESIS

(71) Applicant: VIVOTEXT LTD., Misgav (IL)

(72) Inventors: Yossef BEN-EZRA, Rehovot (IL); Shai NISSIM, Tel-Aviv (IL); Gershon SILBERT, Tel Aviv (IL)

(73) Assignee: VivoText Ltd., Misgav (IL)

(21) Appl. No.: 13/729,312

(22) Filed: Dec. 28, 2012

Related U.S. Application Data
(60) Provisional application No. 61/719,522, filed on Oct. 29, 2012.

(51) Int. Cl. G10L 13/08

(52) U.S. Cl. CPC G10L 13/08
USPC 704/260

(57) ABSTRACT

A method for generation of a prosody adjusted digital sound. The method comprises receiving at least a sensory signal from at least one sensor; generating a digital sound respective of an input text content and a text-to-speech content retrieved from a memory unit; and modifying the generated digital sound respective of the at least the sensory signal to create the prosody adjusted digital sound.

### CROSS-REFERENCE TO RELATED APPLICATIONS

This application claims the benefit of U.S. provisional application No. 61/719,522 filed on Oct. 29, 2012, the contents of which are herein incorporated by reference.

### TECHNICAL FIELD

The invention generally relates to text-to-speech systems, and more specifically to systems that generate prosody in text-to-speech techniques responsive to an input signal.

### BACKGROUND

These days there are numerous products, for example electro-mechanical devices, that use speech synthesis, such as text-to-speech (TTS) synthesis. The speech synthesis is used to create a human speech from a text or from pieces of recorded speech that are stored in a database of the mechanical device. However, current technologies do not seem to perform well, which has resulted in limited adoption of speech synthesis products. Notably, products that are using a synthetically produced voice usually fail to produce a voice that sounds as natural as human speech. Further, the speech synthesis products currently available are configured to produce sounds that are typically homogeneous. Such products have limited ability to provide a prosody of speech that would be comfortably recognizable as human speech.

It would therefore be advantageous to provide a solution that overcomes the deficiencies of the prior art by providing an unlimited variety of prosody that would be recognizable as a desired human-sounding speech.

### SUMMARY

Certain embodiments of disclosed herein include an apparatus for generating prosody adjusted sound. The apparatus comprises a memory unit for maintaining at least a library that contains information to be used for text-to-speech conversion, the memory unit further maintains exactable instructions; at least one sensor; and a processing unit connected to the memory unit and to the at least one sensor, the processing unit is configured to execute the instructions, thereby causing the apparatus to: convert a text content into speech content respective of the library, and generate a prosody adjusted digital sound respective of the speech content and at least a sensory signal received from the at least one sensor.

Certain embodiments of disclosed herein also include a method for generation of a prosody adjusted digital sound. The method comprises receiving at least a sensory signal from at least one sensor; generating a digital sound respective of an input text content and a text-to-speech content retrieved from a memory unit; and modifying the generated digital sound respective of the at least the sensory signal to create the prosody adjusted digital sound.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of an apparatus according to one embodiment.

FIG. 2 is a flowchart describing the generation of a prosody adjusted text-to-speech according to one embodiment.

FIG. 3 is a flowchart describing the determination of a standard of modification required in order to create a prosody adjusted digital sound according to one embodiment.

FIG. 4 is a schematic diagram describing the communication between at least an apparatus and a user node according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein include techniques for controlling prosody of a text-to-speech apparatus responsive of a sensory signal. In one embodiment, the disclosed techniques are utilized in an apparatus, such as, but not limited to, an electro-mechanical toy. In an exemplary embodiment, the apparatus includes one or more physical or virtual sensors, a digital-to-analog convertor (DAC), a processing unit, a library containing metadata such as speech samples, a database that contains the likes of events, expression, sounds, text content, and so on. A digital sound is generated by the apparatus respective of the text content stored in the database. Further, the apparatus modifies the generated digital sound respective of sensory signals received from the sensors, so as to impact the prosody of the digital sound. The modified digital sound then being, for example, delivered to the DAC.

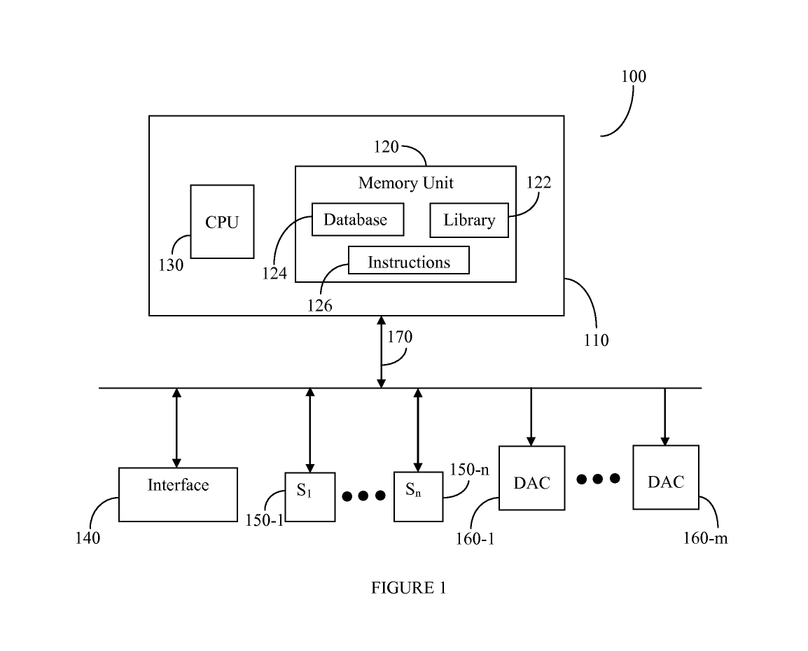

FIG. 1 is an exemplary and non-limiting schematic diagram of an implemented apparatus 100 according to an embodiment. The apparatus 100 typically includes a text-to-speech (TTS) synthesizer 110, which in a preferred embodiment also performs general control functions. In one exemplary and non-limiting embodiment, the TTS synthesizer 110 includes a memory unit 120. The memory unit 120 includes a library 122 of speech samples that are based on pronunciation of at least one phoneme with musical parameters. In an exemplary and not-limiting embodiment, the musical parameters include, but are not limited to, a pitch, a duration, an intensity, and the like of a signal and/or gender, accent, dialect, pronunciation, language and the like, of a speaker. The library 122 can be generated by means of the techniques described in U.S. Pat. No. 8,340,967, which is assigned to the common assignee and hereby incorporated by reference for all that it contains.

The memory unit 120 also includes a database 124 that is comprised of possible events, expressions, sounds, text content, and so on. The possible events may be different scenarios and their respective responses. The sounds are stored in the database 124 mentioned above, and may include digital representation of sound waves. The text content may be used to provide the sound respective of a speech by means of text-to speech (TTS) synthesis.

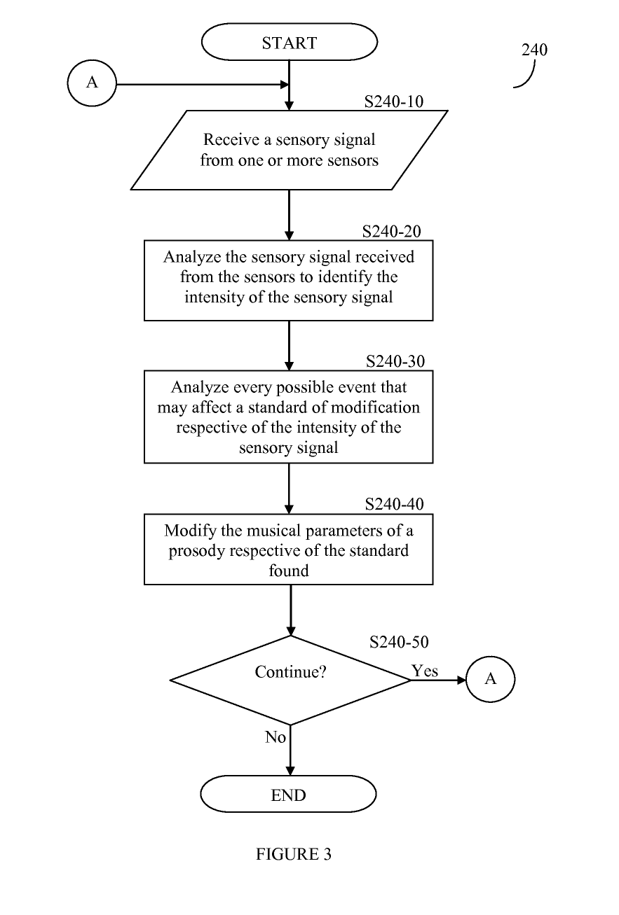

A processing unit 130, may be a part of the TTS synthesizer 110, or connected thereto as an external component. In one embodiment, the apparatus 100 includes an interface 140 that is connected to the processing unit 130 via a communication bus 170. In an embodiment disclosed herein, the interface 140 is also utilized to connect the apparatus 100 to a local network and/or a global network as further described herein below with respect of FIG. 3. The interface 140 is connected to the local network to provide connectivity between the apparatus 100 and at least one of: at least a user node, and at least a second apparatus. The local network is typically a short range wired or wireless limited network, for example, but not limited to, WiFi, ZigBee®, ANT, Bluetooth®, the like, and any combinations thereof. A user node may be, for example, but not limited to, a personal computer (PC), a notebook computer, a cellular phone, a smart phone, a tablet device, and the like. Each one of the second apparatuses has at least a second library containing information to be used for text-to-speech conversion.

In one embodiment, the apparatus 100 is configured to receive sensory signals from one or more sensors 150-1 through 150-n connected to the processing unit 130 through the communication bus 170. Each one of the sensors 150-1 through 150-n may be a physical sensor or a virtual sensor. Each one of the physical sensors 150 may be, for example, but not limited to, a temperature sensor, a global positioning system (GPS), a pressure sensor, a light intensity sensor, an image analyzer, a sound sensor, an ultrasound sensor, a speech recognizer, a moistness sensor, and so on. For example, a sensor 150 may provide an input of an image. Each virtual sensor 150 is communicatively connected to a global network through the interface 140 over which each virtual sensor receives data. A virtual sensor 150, for example, can collect location data based on the IP address of the interface 140 through proper identification of such a location. The global network can be wired or wireless, the Internet, the worldwide web (WWW), and the like, and any combinations thereof.

The memory unit 120 includes instructions 126 executed by the processing unit 130 when a request to convert a text-to-speech is received. Thus, the apparatus 100 receives a sensory signal from one or more of the sensors 150-1 through 150-n, for example 150-1. Typically, the apparatus 100 generates a digital sound representation respective of the text content stored in the database 124 and the information stored in the library 122. The database 124 may be part of the apparatus 100, or connected thereto as an external component. The database 124 as an external component is configured to collect data accessible via the interface 140.

According to one embodiment, the apparatus 100 is configured to modify the generated digital sound. The modification is performed responsive of the signal received from the sensor 150-1 to create a prosody respective of the sound of the text content retrieved, for example, from the memory unit 120. It should be understood that the prosody may be changed, for example, respective of a desired accent, a dialect, pronunciation, a language, and so on. In one embodiment, the apparatus 100 creates a prosody adjusted digital sound respective of the sensory signal received from one or more sensors 150, the data received from a network through the interface 140, and/or the data stored in the database 124. The data may be for example, but not limited to, text, phoneme, addresses to phoneme, difference equation, and so on.

It should be appreciated that the created prosody adjusted digital sound may be speech or part thereof, a voice, an expression, a sung tune, and the like. The creation of the prosody adjusted digital sound, i.e., a sound modification, is performed by replacing sounds, or portions thereof, from sounds stored in the database 124. In another embodiment, a digital signal processor (DSP) performs the function of sound modification. The standards of modification required to be made are described with respect of FIG. 3.

Following is a non-limiting example for creating prosody adjusted digital sound based on a sensory signal received from a sensor 150. In this example, the sensor 150 provides an input of an image. The processing unit 130 may analyze the image to produce a prosody respective of emotions identified in the image. For example, a different prosody of the same sound input may be imposed if the image identifies a smiling face versus an upset face.

In one embodiment, when the apparatus 100 generates sounds respective of difference equations, the modification is performed by changing the mathematical model. In another embodiment, the apparatus 100 may generate an ultrasound respective of text content stored in the database 124 as means of communication between the apparatus 100 and at least the second apparatus.

According to various embodiments, the apparatus 100 may be embodied in an electro-mechanical device, such as but not limited to, a toy or a robot. Furthermore, one or more digital-to-analog convertors (DAC) 160-1 through 160-m are connected to the processing unit 130 via the communication bus 170. Each DAC 160 is used to create an analog signal from the prosody adjusted digital sound. The analog signal is provided to, for example, a loudspeaker (not shown) that is coupled to a DAC 160, for example DAC 160-1, for transformation of the analog signal to sound audioable waves. Another DAC 160, for example DAC 160-m, may be configured to generate an analog signal to cause a motion of the electro-mechanical device, respective of the prosody adjusted digital sound.

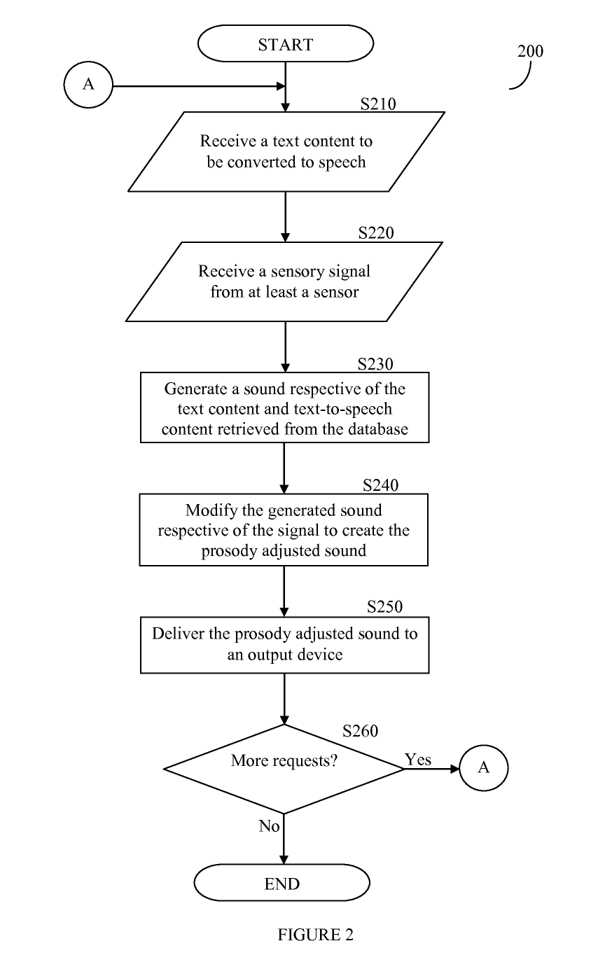

FIG. 2 shows an exemplary and non-limiting flowchart 200 describing the generation of a prosody adjusted text-to-speech responsive of a sensory signal of an embodiment. In S210, a text content to be converted to a speech from a device is received. In S220, a sensory signal from one or more sensors 150-1 through 150-n is received. In S230, a digital sound respective of the text content and text-to-speech content is retrieved, for example, from the memory unit 120 from which the digital sound is generated. In S240, the generated digital sound respective of the sensory signal is modified to create a prosody adjusted digital sound.

In S250, the generated prosody adjusted digital sound is fed to a DAC, e.g., DAC 160-1 being used to create an analog signal. In one embodiment, the analog signal is provided to a loudspeaker (not shown) for transformation of the analog signal to physical sound waves. In another embodiment, the analog signal is provided to a mechanical device to cause a motion of the electro-mechanical device, for example, with respect of a prosody adjusted sound. In S260, it is checked whether there are additional requests, and if so execution continues with S210; otherwise, execution terminates.

In one embodiment, the method disclosed herein is performed by the apparatus 100. The apparatus 100 is configured to use the prosody adjusted digital sound, when the apparatus 100 receives at least one of: a request to convert a text-to-speech from a device, and/or a sensory signal from one or more sensors 150-1 through 150-n.

FIG. 3 describes an exemplary and non-limiting flowchart 300 for the determination of a standard of modification needed in order to create a prosody adjusted digital sound according to one embodiment. In S240-10, a sensory signal from one or more sensors 150-1 through 150-n is received. In S240-20, the sensory signal is analyzed to identify the intensity of each sensor 150. The intensity is measured between −1 and 1 depending upon the type of the sensor 150. In one exemplary embodiment, a sound sensor may set a value equal to 1 or less. High intensity of sound received through the sound sensor is represented with a value equal to 1. In another exemplary embodiment, identification of an absence of light through a light intensity sensor is represented with a value equal to 0. In yet another exemplary embodiment, a measurement of item acceleration in an open space may be represented with value equal to −1.

In S240-30, every possible event is analyzed to determine if a value represents the possibility to affect the standard of the modification of musical parameters respective of the intensity of each sensor 150. The possible events are different scenarios and their respective responses. The musical parameters include, but are not limited to, a pitch parameter, a duration parameter, a volume parameter, and the like. In S240-40, the modification of the musical parameters is performed respective of the standard of the determined modification. The process for determined standard modification is discussed above. In S240-50, it is checked whether additional sensory signals are received, and if so execution continues with S240-10; otherwise, execution terminates.

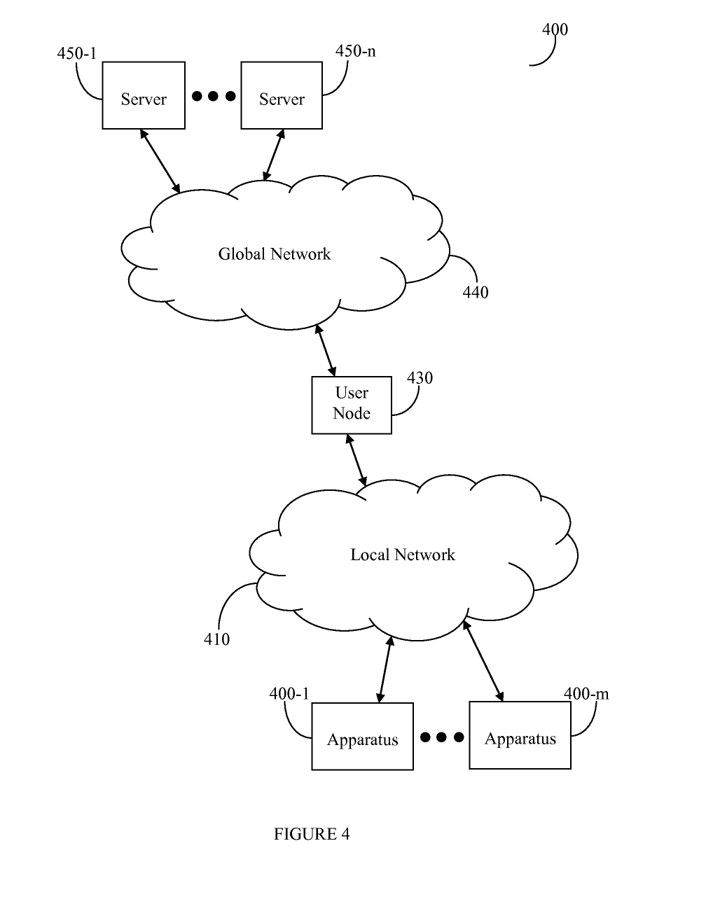

FIG. 4 depicts an exemplary and non-limiting schematic diagram of a system 400 in which the apparatus 100 can operate according to one embodiment. A local network 410, such as a short range wired or wireless limited network, for example, but not limited to, WiFi, ANT, Bluetooth® or ZigBee®, provides connectivity between one or more apparatuses 100-1 through 100-m and at least a user node 430. The apparatus 100 is described in greater detail above with respect to FIG. 1. The user node 430 may be, for example but not limited to, a personal computer (PC), a notebook computer, a cellular phone, a smartphone, a tablet device, and the like. In one embodiment, the user node 430 may be a gateway apparatus similar to the apparatuses 100 having additional functionalities. The user node 430 is communicatively connected to a global network 440. The network 440 can be wired or wireless, the Internet, the worldwide web (WWW), the like, and any combinations thereof.

A plurality of data resources 450, such as web servers 450-1 through 450-n, that provide data, for example, upon request of the user node 430, are also communicatively connected to the global network 440. In one embodiment, the user node 430 may control the operation of at least an apparatus 100, for example apparatus 100-1. The apparatus 100-1 is configured to create a prosody adjusted digital sound respective of a sensory signal received from at least one sensor 150 and, in some implementations, from data received through the global network 440. The process for creating the prosody adjusted digital is described in detail above.

The embodiments described herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The foregoing detailed description has set forth a few of the many forms that the present invention can take. It is intended that the foregoing detailed description be understood as an illustration of selected forms that the invention can take and not as a limitation to the definition of the invention. It is only the claims, including all equivalents thereof, that are intended to define the scope of this invention.

What is claimed is:

1. An apparatus for generating prosody adjusted sound, comprising:
a memory unit for maintaining at least a library that contains information to be used for text-to-speech conversion, the memory unit further maintains exactable instructions;
at least one sensor; and
a processing unit connected to the memory unit and to the at least one sensor, the processing unit is configured to execute the instructions, thereby causing the apparatus to: convert a text content into speech content respective of the library, and generate a prosody adjusted digital sound respective of the speech content and at least a sensory signal received from the at least one sensor.

2. The apparatus of claim 1, further comprises:
a digital-to-analog converter (DAC) configured to receive the prosody adjusted digital sound and to generate an analog signal therefrom.

3. The apparatus of claim 1, wherein the at least one sensor is any one of: a physical sensor, a virtual sensor.

4. The apparatus of claim 3, wherein the physical sensor is any one of: a temperature sensor, a global positioning system (GPS), a pressure sensor, a light intensity, an image analyzer, a sound sensor, an ultrasound sensor, a speech recognizer, a moistness sensor.

5. The apparatus of claim 3, wherein the virtual sensor is a data receiving component communicatively connected to a global network through an interface.

6. The apparatus of claim 5, wherein the interface is further configured to provide connectivity through a local network between the apparatus and at least one of: at least one user node and at least another apparatus.

7. The apparatus of claim 6, wherein the local network is one of: WiFi, ZigBee, Bluetooth, ANT.

8. The apparatus of claim 6, wherein the at least another apparatus further includes at least a second library containing information to be used for text-to-speech conversion.

9. The apparatus of claim 1, further comprises:
a database of at least possible events, expression, sounds, text content and difference equation communicatively connected to the processing unit.

10. The apparatus of claim 9, wherein the processing unit is further configured to:
collect data accessible via the interface; and
save the collected data in the database.

11. The apparatus of claim 9, wherein the processing unit is further configured to adjust the prosody respective of at least one of: data received through the interface and data stored in the database.

12. The apparatus of claim 1, wherein the apparatus is embodied in an electro-mechanical device.

13. The apparatus of claim 12, wherein the electro-mechanical device is any one of: a toy, a robot.

14. The apparatus of claim 12, wherein the processor is further configured to generate a motion of the electro-mechanical device respective of the generated prosody adjusted digital sound.

15. The apparatus of claim 1, wherein the processing unit is further configured to generate an ultrasound respective of text content and text-to speech content retrieved from the memory unit as a means of communication between the apparatus and the at least another apparatus.

16. The apparatus of claim 1, wherein generation of the prosody adjusted sound is performed with respect of musical parameters.

17. The apparatus of claim 16, wherein each of the musical parameters is at least one of: a pitch of a signal, a duration of a signal, an intensity of a signal, an accent, a dialect, pronunciation, a language, and a speaker.

18. A method for generation of a prosody adjusted digital sound, comprising:
receiving at least a sensory signal from at least one sensor;
generating a digital sound respective of an input text content and a text-to-speech content retrieved from a memory unit; and
modifying the generated digital sound respective of the at least the sensory signal to create the prosody adjusted digital sound.

19. The method of claim 18, further comprising:
generating an analog signal by a digital-to-analog converter (DAC) respective of the prosody adjusted digital sound.

20. The method of claim 18, wherein the at least one sensor is any one of: a physical sensor, a virtual sensor.

21. The method of claim 20, wherein the physical sensor is any of: a temperature sensor, a global positioning system (GPS), a pressure sensor, a light intensity, an image analyzer, a sound sensor, an ultrasound sensor, a speech recognizer, a moistness sensor.

22. The method of claim 20, wherein the virtual sensor is a data receiving component communicatively connected to a global network through an interface.

23. The method of claim 20, further comprising:
communicating with at least one of: at least one user node and at least another apparatus, wherein the communication is achieved through a local network.

24. The method of claim 23, wherein the local network is one of: WiFi, ZigBee, Bluetooth, ANT.

25. The method of claim 18, further comprising:
causing a motion of an electro-mechanical device respective of the generated prosody adjusted digital sound.

26. The method of claim 25, wherein the electro-mechanical device is any one of: a toy, a robot.

27. The method of claim 18, wherein the memory unit is further comprised at least one of: a library of information to be used for text-to-speech conversion and a database, wherein the database further comprises at least one of: possible events, expression, sounds, text content, difference equations.

28. The method of claim 27, further comprising:
collecting data accessible via the interface into the database.

29. The method of claim 28, further comprising:
modifying a generated digital sound respective of at least one of: the data received through the interface and a data stored in the database.

30. The method of claim 18, wherein generating the digital sound further comprising:
generating an ultrasound respective of the input text content and the text-to speech content.

31. The method of claim 18, wherein modifying the generated digital sound further comprising one of: replacing the sounds from a database, modifying sounds using a digital signal processor (DSP), and changing the mathematical model of difference equations.

32. The method of claim 31, wherein the DSP further performs at least one of: speech signal processing, digital image processing, and signal processing for communications.

33. The method of claim 18, wherein the prosody adjusted digital sound is created with respect of musical parameters.

34. The method of claim 33, wherein each of the musical parameters is any of: a pitch of a signal, a duration of a signal, an intensity of a signal, an accent, a dialect, pronunciation, a language and a speaker.

35. The method of claim 33, wherein modifying the generated digital sound further comprising:
modifying the musical parameters respective of possible events and an intensity of the at least a sensory signal.

36. A computer software product embedded in a non-transient computer readable medium containing instructions that when executed on the computer perform the method of claim 18.
